(19) United States
(12) Patent Application Publication
(10) Pub. No.: US 2017/0222309 A1
(43) Pub. Date: Aug. 3, 2017

(54) COMPOSITE SYSTEM FOR CONCEALING A SATELLITE DISH

(71) Applicant: KIHO MILITARY ACQUISITION CONSULTING, INC., Vienna, VA (US)

(72) Inventors: Cordian Matthew MAJEWSKI, Mountain Green, UT (US); Mark Vogel, Fort Worth, TX (US); Shelly Barlow, Syracuse, UT (US)

(21) Appl. No.: 15/412,638

(22) Filed: Jan. 23, 2017

Related U.S. Application Data
(60) Provisional application No. 62/290,373, filed on Feb. 2, 2016.
(60) Provisional application No. 62/353,373, filed on Jun. 22, 2016.

(51) Int. Cl. H01Q 1/42; E04C 2/28; E04B 2/00; H01Q 15/16; F16M 13/02; F16M 11/06; H01Q 1/12; E04C 2/54; E04B 5/02

(52) U.S. Cl. CPC H01Q 1/42; E04C 2/54; E04C 2/28; E04C 2/46; E04C 2/50; F16M 13/02; F16M 11/06; H01Q 1/1221; H01Q 15/16; E04C 2002/005

(57) ABSTRACT

A system and method for at least partially concealing a communications antenna without preventing the communications antenna from receiving electromagnetic signals, the system and method comprising a composite material that allows electromagnetic signals to be transmitted therethrough without significant degradation and which may function as a component of a building or structure in which a communications antenna is to be located or to which a communications antenna is to be attached.

### CROSS-REFERENCE TO RELATED APPLICATIONS

This application claims priority to U.S. Provisional Patent Application No. 62/290,373, filed Feb. 2, 2016, and to U.S. Provisional Patent Application No. 62/353,373, filed Jun. 22, 2016, the entirety of both applications hereby incorporated by reference herein.

### FIELD OF THE INVENTION

The present invention relates to a system useful for concealing a communications antenna, such as a satellite dish, that is inside of a building.

### BACKGROUND

Over the past 50 years, the satellite industry has played an important role in many types of data communication, particularly in home entertainment. Fundamental to the satellite industry is the satellite dish, a type of parabolic antenna designed to receive electromagnetic signals from satellites. These electromagnetic signals in turn communicate data transmissions or broadcasts, such as for satellite television and satellite internet.

However, there are certain drawbacks associated with the satellite dish. For example, satellite dishes can be conspicuous and unsightly, often leading to restrictions on their use in some communities. In addition, installation of the satellite dish can often be dangerous or cause damage, as satellite dishes are often positioned on the roof or outer side of the building receiving the signal.

There is thus a need in the art for systems that overcome certain drawbacks of existing satellite dish technology.

### SUMMARY

Aspects of the present invention are directed generally to a system useful in conjunction with a communications antenna (for example, a satellite dish), particularly a system that at least partially conceals the communications antenna without preventing the communications antenna from receiving electromagnetic signals. According to some aspects, the system comprises a composite material that allows electromagnetic signals to be transmitted therethrough without significant degradation. For example, the composite material may be translucent to an electromagnetic signal. According to some aspects, the system may function as a component of a building or structure in which a communications antenna is to be located or to which a communications antenna is to be attached, and may outwardly resemble, for example, a skylight of the related art. Some aspects of the present invention allow communications antennas to be installed inside of a building without significant loss of signal reception.

Additional aspects of the present invention may include other features related to a communications antenna used in conjunction with such skylight-like building features, such as an adjustable support system for the communications antenna that allows the communications antenna to be readily moved to the proper position within the building for receiving signals via the panel in the skylight-like building features. Such adjustable support system may also provide other uses, such as for lowering the communications antenna for maintenance.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

FIG. 1 shows an example of a system functioning as a continuous portion of a roof, according to aspects of the present invention.

FIG. 2 shows an example of a panel with separate components and/or formed features thereon, according to aspects of the present invention.

FIG. 3 shows an example of a system functioning as a continuous portion of an exterior wall, according to aspects of the present invention.

FIG. 4 shows an example of a system comprising a panel and a mounting structure, according to aspects of the present invention.

FIGS. 5A-5D show example views of a panel comprising a plurality of units and related cutting techniques and orientations, according to aspects of the present invention.

### DETAILED DESCRIPTION OF THE INVENTION

Aspects of the present invention are directed generally to a system useful in conjunction with a communications antenna, particularly a system that at least partially conceals the communications antenna without preventing the communications antenna from receiving electromagnetic signals. According to some aspects, the system comprises a composite material that allows electromagnetic signals to be transmitted therethrough without significant degradation. According to some aspects, the system may function as a component of a building or structure in which a communications antenna is to be located or to which a communications antenna is to be attached, and may outwardly resemble, for example, a skylight of the related art. Some aspects of the present invention allow communications antennae to be installed inside of a building without significant loss of signal reception.

According to some aspects, the system may be installed into a building after the building has been constructed; in other aspects, the system may be installed during building construction.

According to some aspects of the present invention, the system may be configured to function as a portion of the roof of a building. For example, the system may be configured to resemble a skylight in a roof of the building. As used herein, the term “skylight” refers to a light transmitting fenestration which forms a portion or all of a building's roof.

According to some aspects, the system may comprise a skylight panel and a panel mounting mechanism. For example, the skylight panel may be mounted on a frame that is around an opening in a roof.

According to some aspects, the skylight panel may be mounted directly onto a roof surface. For example, the skylight panel may comprise a seal which is fixed directly onto a roof surface with nails, screws, or other attachment mechanisms, such that the skylight panel fits into an opening in the roof.

According to some aspects, the system may resemble a fixed skylight of the related art (e.g., a skylight panel which is fixed to a structural perimeter such that the panel does not move relative to the roof) or an operable skylight (e.g., a skylight panel comprising a hinged portion that allows the skylight panel to move relative to the roof, such as to open and close). According to some aspects, the operable system may resemble a retractable skylight (e.g., a skylight panel configured to roll or move off of a structural perimeter to expose some or all of the building's interior to the outside environment) or a dome-shaped skylight.

According to some aspects, the system may be configured to resemble skylight designs of the related art, for example, VELUX® Skylights. According to some aspects, the system may have an outer perimeter size of about 30″×30″ or 44″×45″, for example. However, one skilled in the art will understand that the examples herein are merely illustrative, as aspects of the present invention may be configured to resemble any type of compatible skylight of the related art.

According to some aspects, the system may be configured to function as a continuous portion of the roof or other surface of a building. For example, according to some aspects, the system may comprise a panel configured to resemble surrounding roof or exterior wall, such that the system is an inconspicuous portion thereof. According to some aspects, the panel may be flush with the roof or exterior wall, and may be generally seamless with regard to the roof or wall surface. For example, according to some aspects, the panel may be the same or similar color, shape, and/or texture as the surrounding roof or wall. According to some aspects, the panel may be comprised of a material which is the same or a similar color to the surrounding roof or exterior wall surface, and/or the panel may be painted or otherwise colored to be the same or similar color to the surrounding roof or exterior wall surface. It should be understood that any paint, dye, or other mechanism or method of coloring the panel that does not prevent sufficient electromagnetic signals from being transmitted therethrough may so be used. Example paint/coating useful in accordance with aspects of the present invention includes Polyamide epoxy type paint or coating made by Devran of Akzo Nobe, and/or Polyurethane High solids per MIL-PRF-85285. According to some aspects, the panel may comprise a texture that is the same or similar as the building components of the roof or exterior wall surface of a building. For example, the panel may be comprised of a material that is textured to resemble roofing material, such as roof shingles, or exterior wall material, such as stucco, siding, brick, or other outer wall materials. According to some aspects, the panel may be prepared using a mold corresponding to the surface of the building components onto which the system is installed.

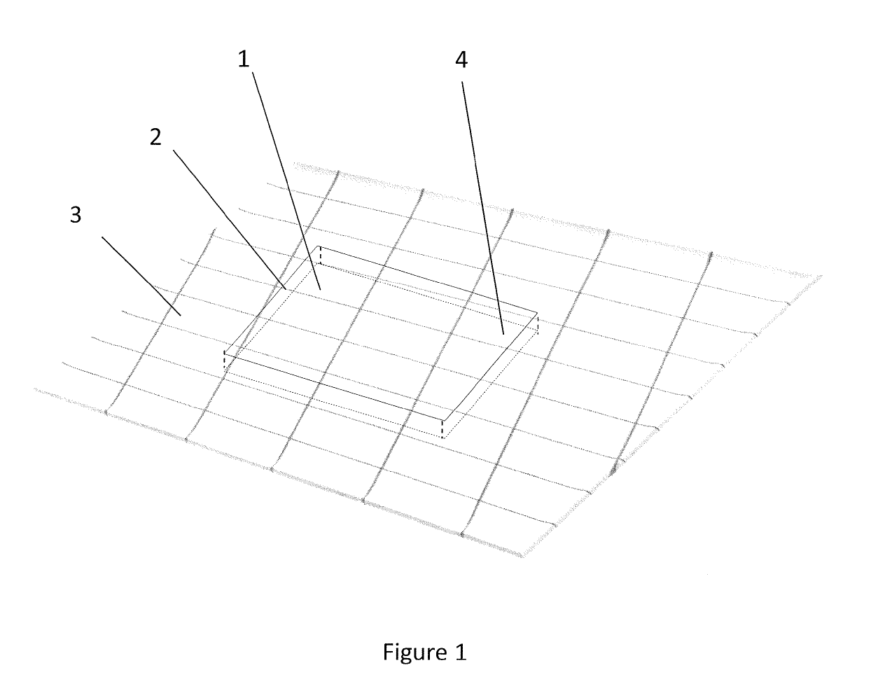

For example, as shown in FIG. 1, the system may comprise a panel (1) receivable into a frame (2) which is configured to fit in an aperture in a roof (3). The panel may have a texture (4) that is the same as or similar to the texture of the surrounding roof (3), and the panel (1) may be flush with the roof (3). In this example implementation, the panel (1) may appear to be a continuous portion of the roof (3).

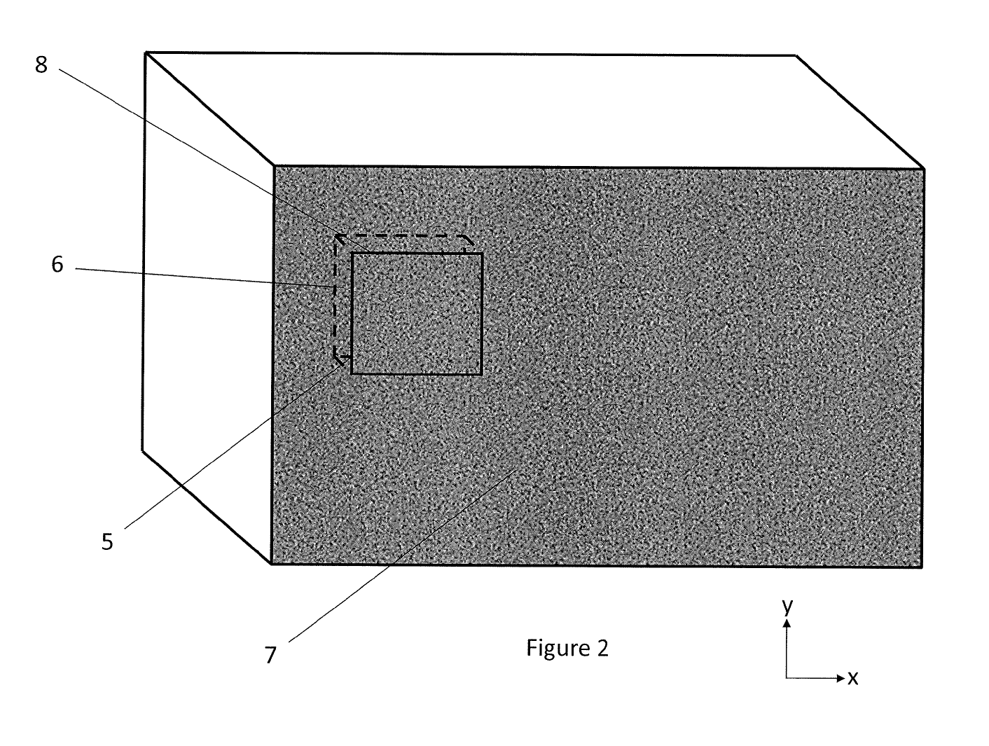

In another example, as shown in FIG. 2, the system may comprise a panel (5) extending in an x and y direction that is receivable into a frame (6), which is configured to fit in an aperture in an exterior wall (7). The panel may include, for example, a texture (8) that is the same as or similar to the exterior texture of the surrounding wall (7), and the panel (5) may fit flush with the exterior wall (7). In this example implementation, the panel (5) may appear to be a continuous portion of the exterior wall (7).

According to some aspects, the system may comprise separate components from the panel which resemble roofing or exterior wall material that are, for example, attached onto the surface of the panel.

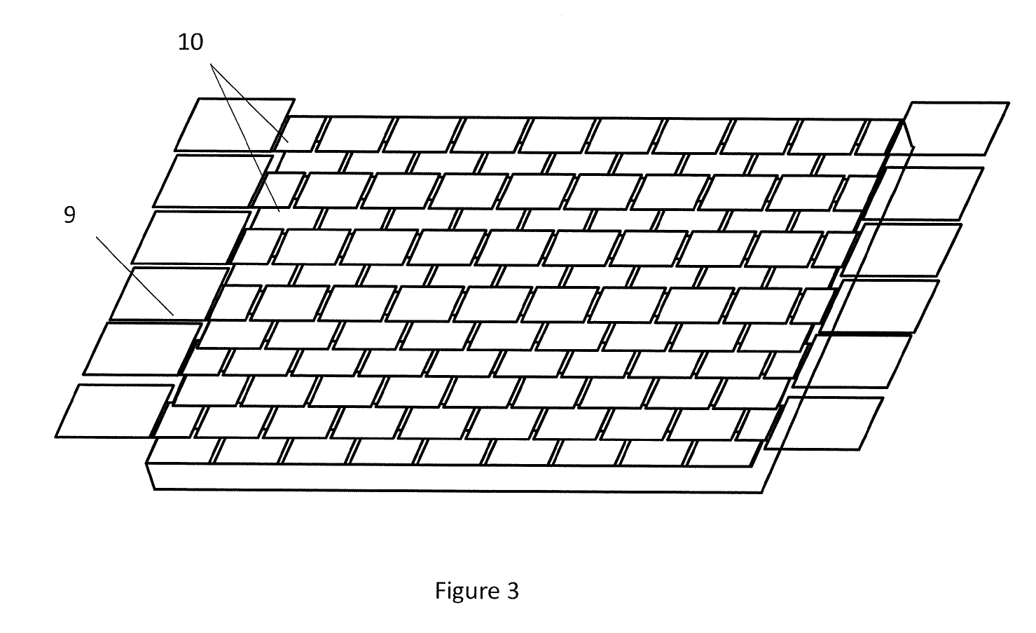

For example, as shown in FIG. 3, the panel (9) may comprise separate components (10) or alternatively formed thereon (e.g., so as to resemble roofing tiles), which are configured to resemble roofing shingles. In this example implementation, the panel (9) may appear to be a continuous portion of a roof in which the system is installed.

According to some aspects, the system may include mountings or other features for placing and/or attaching the system relative to the surrounding roof or wall materials. It should be understood that any texture or components will be such that the system does not prevent electromagnetic signals from being transmitted through the panel, in accordance with aspects of the present invention. Further, according to some aspects of the present invention, the system may comprise one or more composite materials which do not prevent electromagnetic signals from being transmitted therethrough. According to some aspects, the composite material(s) may have sufficient load bearing capacity such that the material is suitable for use in the architecture of a building. According to some aspects, the composite material(s) may be suitable for use outdoors, such that, for example, the composite material is weatherproof or weather resistant.

For example, according to some aspects, the system may include a panel comprised of a flexible fiber, such as an aramid fiber. According to some aspects, the flexible fiber may be fire-resistant and thermally insulating with a high strength-to-weight ratio. The panel may alternatively or further comprise other materials to provide structure for the composite. Such materials may include, for example, DuPont Nomex° Honeycomb, DuPont™ Kevlar® aramid fiber, and/or similar materials. According to some aspects, the thickness of the fiber panel constructed therewith may be about one inch, or may be any suitable thickness more than about 0.25 inches (i.e., 0.25 inches+/−10%), so long as the thickness does not impede.

According to some aspects, the system may include a panel comprising or further comprising a structural foam. For example, the panel may comprise a shear- and pressure-resistant, low density foam, such as a high performance structural foam core made by ROHACELL® of Evonik, and/or similar materials. According to some aspects, the thickness of the foam panel may be about one inch, or may be any suitable thickness more than about 0.25 inches (i.e., 0.25 inches +/−10%).

According to some aspects, the system may include a panel comprised of a material that includes a plurality of repeated units. According to some aspects, the units may be hollow units. For example, the material may comprise a plurality of hollow cells (e.g., hollow hexagonal cells of a honeycomb-like appearing material, and/or hollow cylinders) arranged in a patterned orientation.

For example, according to some aspects, the hollow units may each extend in a direction approximately parallel to each other. According to some aspects, the extending direction of each of the hollow units may be parallel to a direction of the panel's thickness. As used herein, the term “thickness” refers to a direction perpendicular to a plane defined by two perpendicular directions in which the panel extends. According to some aspects, the extending direction of each of the hollow units may be parallel to the direction of the thickness. According to some aspects, the extending direction of each of the hollow units may form an angle with the direction of the thickness that is greater than 0 degrees and less than 90 degrees.

According to some aspects, the units may be shaped so that a signal, such as an electromagnetic signal, passing through the panel is amplified. For example, each unit may have the shape of a “gain horn.” That is, each unit may have an increasing diameter, wherein the diameter is larger at one end of the unit that at the other end. According to some aspects, an electromagnetic signal may be received through the end of the unit having a smaller diameter and transmitted through the unit towards the end with the larger diameter such that the electromagnetic signal is amplified as it passes through the panel.

According to some aspects, the units of the panel may be oriented such that the panel's interference to electromagnetic signals passing therethrough is minimized. According to some aspects, the units may be oriented as a result of a particular cutting pattern and/or method.

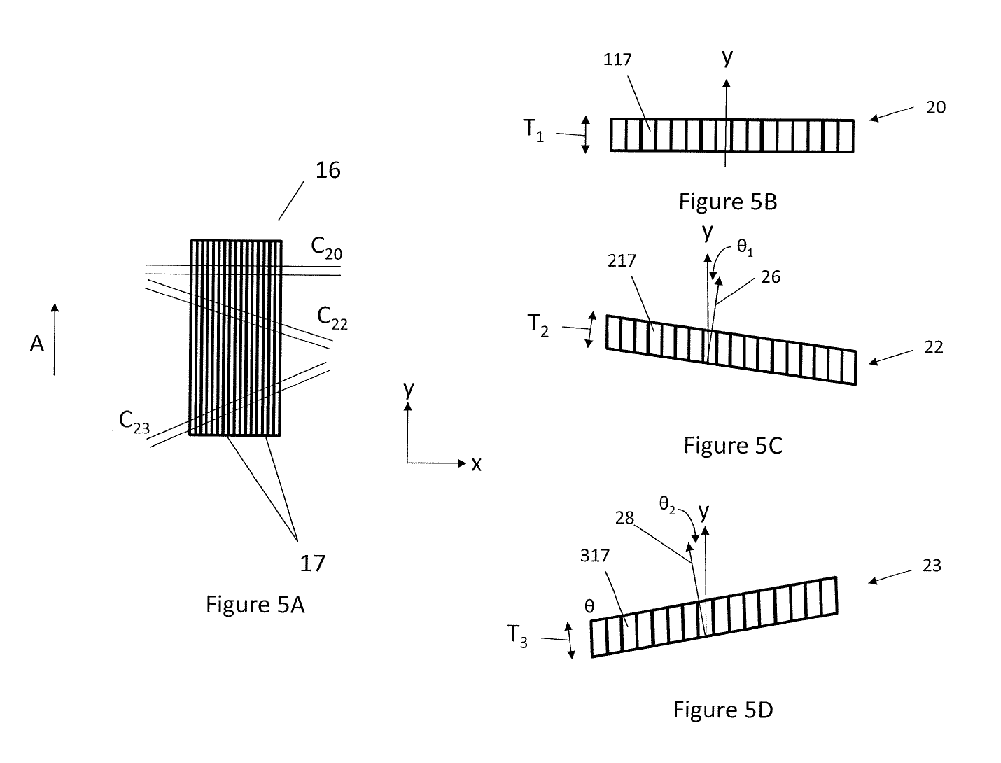

For example, as shown in FIG. 5A, a material (16) for use in producing a panel may comprise a plurality hollow units (17) arranged substantially in parallel rows aligned such that they extend in the long axial direction A of the material (16). In this example, it may be desirable to produce a panel (20) comprising the material (16), in which the section of the units (117) within the panel 20 are oriented so as to extend in direction A, which is parallel to the direction of the thickness T₁ of the panel (20), i.e., the thickness of the panel and the direction of extension A of the cut portions (117) of units (17) of FIG. 5A, are each in the direction of the y axis, as shown in FIG. 5B. As shown in FIGS. 5A and 5B, the material (16) of FIG. 5A may be cut along lines (C₂₀) to properly size the panel (20), with the cut hollow units (117) thereby being oriented as shown in the x and y directions in FIG. 5B. With this arrangement of FIG. 5B, signals incident in the direction of the y axis received within each cut hollow unit (117) may pass therethrough with minimal signal loss.

In other examples, as shown in FIGS. 5C and 5D, it may be desirable to provide a panel (22) or (23), respectively, comprising the material (16) wherein the units (17) are cut from the material so as to be angled in orientation relative to the direction of the thickness (26) of panels (22) and (23). For example, in the case where a panel (22) is installed in an angled roof sloping downward to the right in cross section, as shown in FIG. 5C, the cut units (217) may be correspondingly cut so as to extend at an angle θ₁ between the direction (26) of thickness T₂, and the direction of extension of the cut units (217), which is in the direction of the y axis, such that electromagnetic signals received by the cut units (217) incident in the y direction are able to traverse a path in a direction of minimum signal loss (e.g., a path substantially in the y direction) when the panel (22) is installed on an angled roof. Similarly, for example, in the case where a panel (23) is installed in an angled roof sloping downward to the left in cross section, as shown in FIG. 5D, the cut units (317) may be correspondingly cut so as to extend at an angle θ₂ between the direction (28) of thickness T₃, and the direction of extension of the cut units (317), which is in the direction of the y axis, such that electromagnetic signals received by the cut units (317) incident in the y direction are able to traverse a path in a direction of minimum signal loss (e.g., a path substantially in the y direction) when the panel (23) is installed on an angled roof. According to some aspects, the frame or other features for placing and/or attaching the panel to a surrounding roof or wall materials may be reinforced in order to offset any decreases in strength resulting from cutting the material for sizing and orienting the panel units.

According to some aspects, the fiber or foam panel may be bonded to one or more layers of fiber reinforced plastic, such as fiberglass (for which there are many suppliers) and/or para-aramid fabric (e.g., KEVLAR® made by DuPont). According to some aspects, one or both surfaces of the panel may be attached to one or more layers or sheets of fiberglass. According to some aspects, the fiber or foam panel may “sandwiched” between layers of fiberglass. In some aspects, the panel may comprise one or more layers of fiberglass without a fiber or foam layer therebetween.

According to some aspects, the system may comprise a fabric configured to at least partially camouflage the system. For example, the system may comprise a panel with a fabric layer, such as a fabric layer positioned within the composite such that the fabric is visible from the outside of a building to which the system is attached. According to some aspects, the fabric may be a thin printed and/or perforated fabric that provides the panel with texture or the appearance of texture, or other properties, such as coloring, for example, in order to camouflage the panel relative to the building's outer surface. According to some aspects, the fabric layer may be attached to a layer of fiberglass. According to some aspects, the fabric layer may comprise absorbable material allowing sufficient signals to pass therethrough, such as cotton. Alternatively to a fabric, for example, another material, such a wrap material that allows sufficient signals to pass therethrough, may be similarly placed within the composite or on the composite surface.

According to some aspects, the fiber or foam panel may additionally or alternatively be bonded to one or more protective materials. For example, the system may comprise an outermost layer that provides UV protection to the system. Examples of protective materials include, but are not limited to, a polycarbonate and/or a polyurethane material. For example, the protective material may comprise a Lexan™ polycarbonate sheet. The protective material may be provided on one or multiple faces of the system. For example, the protective material may be provided on one or more faces of the system that are exposed to the environment.

According to some aspects, the protective material may comprise a surface that includes a texture or the appearance of texture, or other properties, such as coloring, in order to camouflage the panel relative to the building's outer surface and/or to provide a desired camouflaging appearance. For example, the protective material may comprise a substantially or completely transparent polycarbonate sheet with a surface design (e.g., texture, coloring) on one side thereof so that the design is visible through the polycarbonate sheet. In this way, the fiber or foam panel is protected and may also be camouflaged relative to a building's other surfaces. (For example, the surface design may take on the appearance of wood, shingles, a solar panel) According to some aspects, the surface design may be, for example, printed onto the protective material and/or comprise a separate material attached to the protective material.

According to some aspects, the layers of the composite material may be bonded together by any suitable features and methods known in the art. For example, the layers may be bonded together using an epoxy adhesive resin with suitable properties for allowing signals to pass therethrough. One such consideration is that the epoxy may have correct dielectric properties. An example of such epoxy is made by PTM&W Industries, Inc. of Santa Fe Springs, Calif.

According to some aspects, the system may allow a sufficient amount of electromagnetic signals to be transmitted therethough without significant distortion resulting in the receiving device (e.g., a received signal to be projected onto a television screen). For example, the system may allow at least 90% or more, and up to 99% or more of an electromagnetic signal to be transmitted therethrough.

According to some aspects, the system may further comprise an adjustable support mechanism for mounting and/or varying the position of a communications antenna used therewith. For example, the system may comprise a mounting structure, such as a pedestal or carriage, configured to support a communications antenna underneath or behind the panel (e.g., within a building beneath a roof having the skylight-like panel, or behind a wall of a building having a panel for transmitting signals emplaced therewithin). According to some aspects, the adjustable support mechanism may allow a user to manipulate the position of the communications antenna. For example, the mounting structure may be lowered, such that the communications antenna may attached thereto and/or moved so as to be serviced or adjusted and raised (e.g., so as to be properly positioned so as to receive signals). According to some aspects, the adjustable support mechanism may allow the communications antenna to be turned, angled, or rotated, otherwise oriented, such that the communications antenna is properly positioned to receive signals.

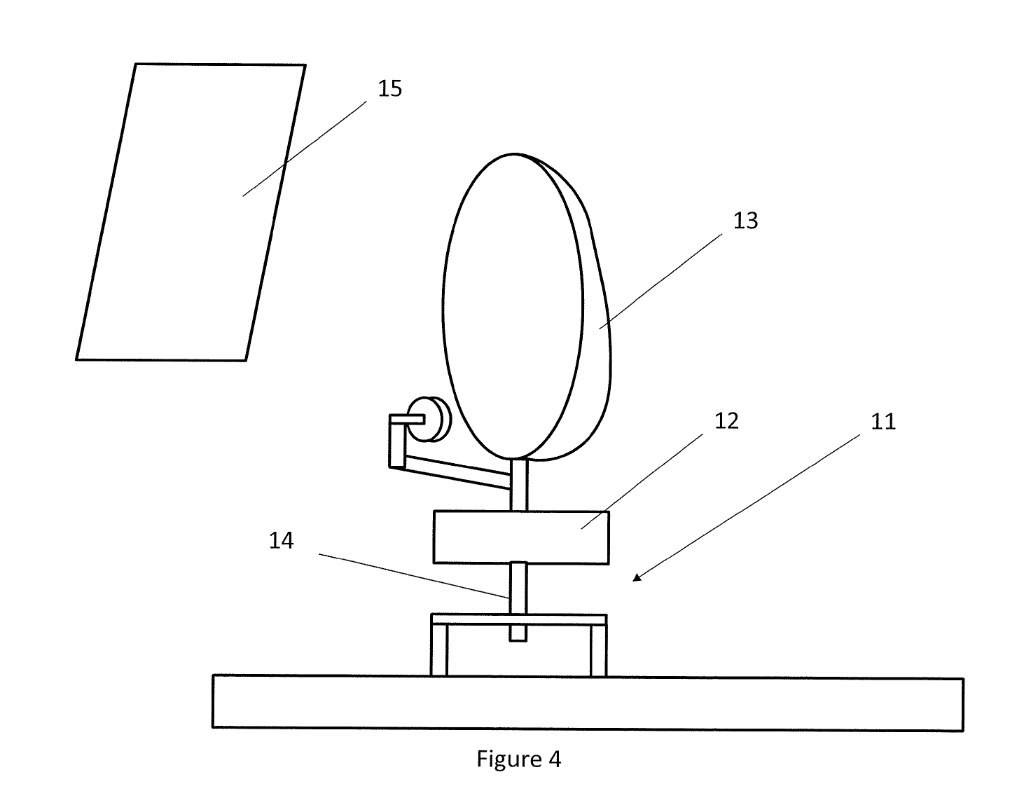

For example, as shown in FIG. 4, the system may comprise a adjustable support mechanism (11), wherein the adjustable support mechanism has a mounting structure (12) for mounting a communications antenna (13) thereon. The adjustable support mechanism (11) may also comprise a moveable structure (14) capable of manipulating the position of the mounting structure (12), such that the mounting structure (12) and the communications antenna (13) can be raised, lowered, turned, angled, and/or rotated. In this example implementation, the adjustable support mechanism (11) may be provided in a building, for example, such that the communications antenna (13) is behind or underneath the panel (15), thereby capable of receiving signals from inside of the building.

According to some aspects, the panel may itself function as a receiving device.

For example, according to some aspects, the panel may have the shape of a lens. As used herein, the term “lens” refers to the shape of a material having two opposite surfaces, either or both being curved, such that the material directs or focuses a signal. According to some aspects, the panel may also comprise one or more receivers for receiving a signal.

For example, according to some aspects, the protective material of the panel may provide a curved surface such that a signal, such as an electromagnetic signal, from outside of a building is directed to the receiver. In this way, the panel may function as a receiving device, negating the need for a separate structure in the system for receiving a signal.

According to some aspects, the system may comprise an additional weather-proofing or other operation enhancing mechanism. For example, the system may comprise a fan or blower configured to heat the panel from the inside of a building in order to melt ice and/or snow on the outer surface of the panel. According to some aspects, the system may alternatively or further comprise a heater element or elements, such as a heating wire, around the perimeter or encompassed within the composite materials of the panel, so as to enable melting of ice and/or snow on the panel.

According to some aspects, the system may comply with all requirements known in the related art. For example, the system may comply with all requirements regarding receipt of sufficient signal strength by a satellite dish used therewith, as well as load, impact, ultraviolet (UV) degradation, water penetration, fall resistance, and fire resistance of the panel and related features. According to some aspects, the system may comply with all requirements as set out by ASTM International, for example, ASTM E1233 (“Standard Test Method for Structural Performance of Exterior Windows, Doors, Skylights, and Curtain Walls by Cyclic Air Pressure Differential”) and ASTM E331 (“Standard Test Method for Water Penetration of Exterior Windows, Skylights, Doors, and Curtain Walls by Uniform Static Air Pressure Difference”).

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

What is claimed is:

1. A system comprising a panel, wherein the panel comprises a composite material that allows at least 90% of an electromagnetic signal to transmit therethough, and wherein the panel is configured to form a portion of a roof of a building.

2. A device for shielding a communications antenna for use with a building structure, the device comprising:
a frame attachable to a component of the building structure, the component having a shape or color characteristic; and
a composite panel receivable into the frame, the panel including:
a first composite material that is translucent to an electromagnetic signal, the first composite material providing structural support for the composite panel; and
a second composite material bindable with the first composite material to form the composite panel, the second composite material being translucent to the electromagnetic signal;
wherein the composite material is formed or colored to match the shape or color characteristic of the component of the building structure.

3. The device according to claim 2 further comprising a coloring additive.

4. The device according to claim 2 further comprising a paint or coating translucent to the electromagnetic signal.

5. The device according to claim 2 further comprising an adjustable support mechanism for the communications antenna.

6. the device according to claim 2 wherein the communications antenna is a satellite dish.

7. The device according to claim 2 wherein forming includes placing the composite panel in a mold prior to curing.

8. The device according to claim 2 wherein the component is a roof.

9. The device according to claim 2 wherein the component is a wall.

10. The device according to claim 2 wherein the first composite material comprises fiberglass.

11. The device according to claim 2 wherein the first composite comprises a structural foam.

12. The device according to claim 2 wherein the second composite material is an epoxy resin.

13. The device according to claim 2, wherein the composite panel comprises a plurality of aligned hollow units.

14. The device according to claim 13, wherein the composite panel extends in two perpendicular directions lying in a plane, wherein the composite panel has a thickness in a direction perpendicular to the plane, wherein each of the hollow unit extends in a direction parallel to each other hollow unit, and wherein the extending direction of each of the hollow units is parallel to the direction of the thickness.

15. The device according to claim 13, wherein the composite panel extends in two perpendicular directions lying in a plane, wherein the composite panel has a thickness in a direction perpendicular to the plane, wherein each of the hollow unit extends in a direction parallel to each other hollow unit, and wherein the extending direction of each of the hollow units forms an angle with the direction of the thickness that is greater than 0 degrees less than 90 degrees.

16. The device according to claim 13, wherein at least one of the plurality of hollow units comprises an outer surface having at least a portion of increasing diameter between a first end to a second end such that the unit is configured to amplify the electromagnetic signal.

17. A system comprising a panel, wherein the panel comprises a composite material and a receiver, wherein the panel has a curved surface configured to direct an electromagnetic signal to the receiver, and wherein the panel is configured to form a portion of a building.

18. The system according to claim 17, wherein the composite material comprises a first composite material and a second composite material bindable with the first composite material.

19. The system according to claim 18, wherein the first composite comprises is a structural foam.

20. The device according to claim 18 wherein the second composite material comprises a polycarbonate and/or a polyurethane material.
